(19) United States
(12) Patent Application Publication
(10) Pub. No.: US 2026/0032571 A1
(43) Pub. Date: Jan. 29, 2026

(54) RADIO ACCESS TECHNOLOGY NETWORK SELECTION ENHANCEMENTS FOR THE UE

(71) Applicant: InterDigital Patent Holdings, Inc., Wilmington, DE (US)

(72) Inventors: Anuj SETHI, Ottawa (CA); Michael STARSINIC, Newtown, PA (US); Ulises OLVERA-HERNANDEZ, Saint-Lazare (CA); Saad AHMAD, Montreal (CA); Guanzhou WANG, Brossard (CA); Rocco DI GIROLAMO, Laval (CA); Taimoor ABBAS, Sainte-Julie (CA)

(73) Assignee: InterDigital Patent Holdings, Inc., Wilmington, DE (US)

(21) Appl. No.: 18/787,535

(22) Filed: Jul. 29, 2024

(51) Int. Cl. H04W 48/18; H04W 60/00; H04W 84/04

(52) U.S. Cl. CPC H04W 48/18; H04W 60/005; H04W 84/042

(57) ABSTRACT

A method and apparatus for performing network selection are described. A method may include performing a first registration procedure on a first PLMN, the registration procedure including a capability of a WTRU to support a RAT utilization feature, the RAT utilization feature corresponding to RAT access information. The WTRU may receive a registration accept message or a WTRU configuration update message including RAT utilization information, where the RAT utilization information includes one or more entries, each entry including at least one PLMN Identifier and a corresponding priority and each entry includes validity information for one or more RATs. The WTRU may store the RAT utilization information. The WTRU may perform a PLMN/cell selection procedure according to the stored RAT utilization information, and may determine to perform a second registration procedure with a second PLMN, based on the second PLMN having a PLMN identity corresponding to the highest priority.

### BACKGROUND

Radio Access Technology (RAT) network selection is a process used in mobile communication systems to determine which type of radio access network a mobile device should connect to. RAT refers to the underlying technology used for wireless communication, such as GSM, UMTS, LTE, 5G NR, Wi-Fi etc. Network selection ensures that a device connects to the most appropriate network based on various factors. These factors include users' preferences, operator policies, network availability, and subscription and roaming agreements. Roaming services (national and international roaming) are vital for ensuring seamless connectivity, especially in areas where the home network operator lacks coverage. However, allowing inbound roamers unrestricted use of the RATs of the visited network can pose technical issues which can further degrade the visited network performance. Existing mechanisms to limit a user equipment's utilization of certain RATs of various networks involves rejecting the user equipment's (UEs) or wireless transmit/receive unit's (WTRUs) attach/TAU/registration. The existing mechanism may result in higher signaling loads, within the network, to transmit the attach/TAU/Registration request messages and subsequent reject messages, service outage for the UE/WTRU until the UE/WTRU selects another RAT, and in the UE/WTRU re-attempting to attach to the same PLMN/RAT upon the UE/WTRU re-enabling the corresponding RAT. For example, the UE/WTRU implementation specific timer based disabling/re-enabling of the RAT.

### SUMMARY

Aspects and features of the disclosed embodiments include a user equipment (UE) or wireless transmit/receive unit (WTRU) performing a registration procedure and/or PLMN/Cell selection or reselection. In one general aspect, a method may include performing a first registration procedure on a first public land mobile network (PLMN), the registration procedure including a capability of the WTRU to support a RAT utilization feature, where the RAT utilization feature corresponds with RAT access information. The method may also include receiving a registration accept message or a WTRU configuration update message that includes RAT utilization information, where the RAT utilization information includes one or more entries and each entry includes at least one PLMN identifier and a corresponding priority, and each entry includes validity information for one or more RATs. The method may furthermore include storing the RAT utilization information received with the registration accept message or with the WTRU configuration update message. The method may, in addition, include performing a PLMN or cell selection procedure according to the stored RAT utilization information, and determining to perform a second registration procedure with a second PLMN, based on the second PLMN having a PLMN identity corresponding to the highest priority. Other embodiments of this aspect include corresponding computer systems, apparatus, and computer programs recorded on one or more computer storage devices, each configured to perform the actions of the methods.

Implementations may include one or more of the following features. The method where the RAT utilization information includes multiple entries for each of one or more other PLMNs, and where the multiple entries for each of the one or more other PLMNs includes: an entry identifier, a PLMN identifier, and corresponding RAT validity information. The method where the WTRU configuration update message includes updated RAT utilization information when the RAT utilization information is changed. The method where the RAT utilization information is included in an operator controlled PLMN selector with access technology (OPLMN) controlled by a mobile network operator. The method where updated RAT utilization information is received via a non-access stratum (NAS) downlink (DL) NAS transport message as part of a steering of roaming (SoR) transparent container. The method where the RAT utilization information includes WTRU network slice parameters including location validity information and time validity information. The method may include receiving broadcast information from a network node, the broadcast information including a flag to indicate whether RAT utilization is supported. The method may include transmitting a system information on demand request to the network node. The method may include: receiving an entry identifier in the broadcast information and selecting an entry from the RAT utilization information for a PLMN selection/reselection procedure based on the broadcast information received. The method may include completing the second PLMN registration procedure with the second PLMN. Implementations of the described techniques may include hardware, a method or process, or a computer tangible medium.

In one general aspect, the method may be performed by a WTRU. The WTRU may include processing circuitry and a transceiver where the transceiver is configured to perform a first registration procedure on a first PLMN, the registration procedure including a capability of the WTRU to support the RAT utilization feature, the RAT utilization feature corresponding to RAT access information. The transceiver may be configured to receive a registration accept message or a WTRU configuration update message including RAT utilization information, where the RAT utilization information includes one or more entries and each entry includes at least one PLMN Identifier and a corresponding priority and each entry includes validity information for one or more RATs. The processing circuitry may be configured to store the RAT utilization information received with the registration accept message or with the WTRU configuration update message. The processing circuitry may be configured to perform a PLMN or cell selection procedure according to the stored RAT utilization information, and may instruct the transceiver to perform a second registration procedure with a second PLMN, based on the second PLMN having a PLMN identity corresponding to the highest priority. Other embodiments of this aspect include corresponding computer systems, apparatus, and computer programs recorded on one or more computer storage devices, each configured to perform the actions of the methods.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates a RAT Utilization information delivery and storage process during a WTRU registration procedure;

FIG. 3 illustrates a RAT Utilization information process for PLMN selection; and

FIG. 4 is a flow diagram of an exemplary RAT utilization process.

### DETAILED DESCRIPTION

### Abbreviations and Acronyms

AMF Access and Mobility Function
AF
Application Function
Closed Access Group
CAG
EHPLMN Equivalent Home PLMN
eHN equivalent Hosting Networks
FPLMN Forbidden PLMN
eSNPN equivalent SNPNs
GUI Graphical User Interface
GIN Group ID for Network Selection
HPLMN Home Public Land Mobile Network
IE Information Element
IMSI International Mobile Subscriber Identity
LR Location Register
MCC Mobile Country Code
MNC Mobile Network Code
MS Mobile Station
NAS Non-Access Stratum
NG Next Generation
NPN Non-Public Network
NS Network Slicing
NSSAI Network Slice Selection Assistance Information
NSSAA Network Slice-Specific Authentication and Authorization
NWDAF Network Data Analytics Function
OPLMN Operator Controlled PLMN (Selector List)
PALS Providing Access to Localized Services
PLMN Public Land Mobile Network
PNI-NPN Public Network Integrated NPN
RA Registration Area
RAN Radio Access Network
RAT Radio Access Technology
RFSP RAT/Frequency Selection Priority
RPLMN Registered Public Land Mobile Network
S-NSSAI Single NSSAI
SIM Subscriber Identity Module
SNPN Stand Alone NPN
SoR Steering of Roaming
SOR-SNPN-SI-LS SoR SNPN Selection Information for Localized Services
SUPI Subscription Permanent Identifier
TA Tracking Area
TAI TA Identity
UE User Equipment
SNPN Standalone NPN
UICC Universal Integrated Circuit Card
USIM UICC with SIM
VPLMN Visited Public Land Mobile Network

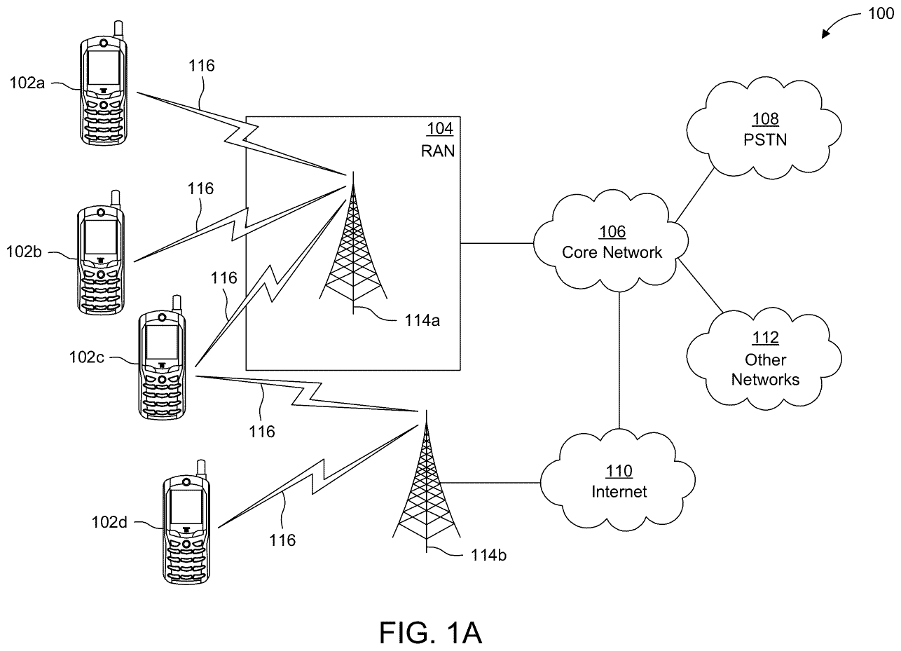

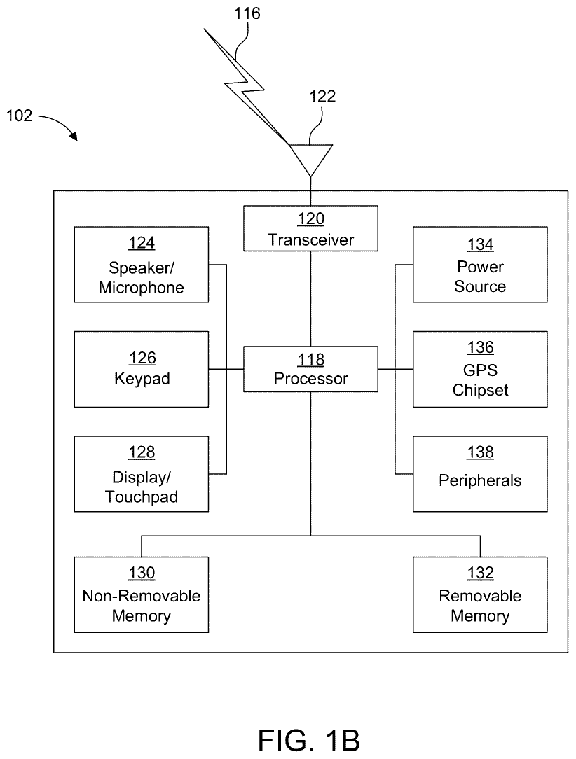

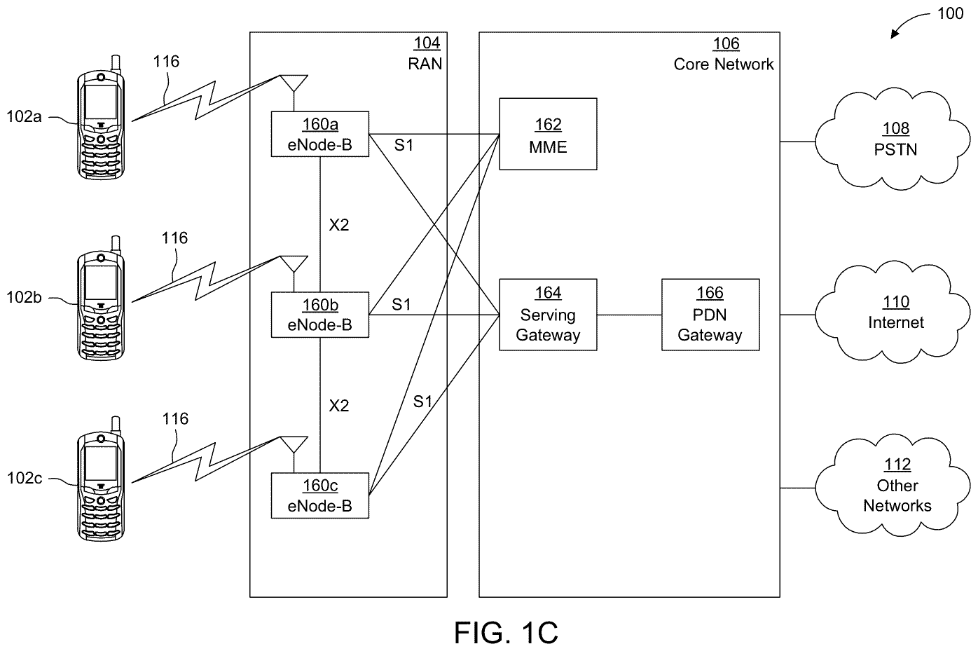

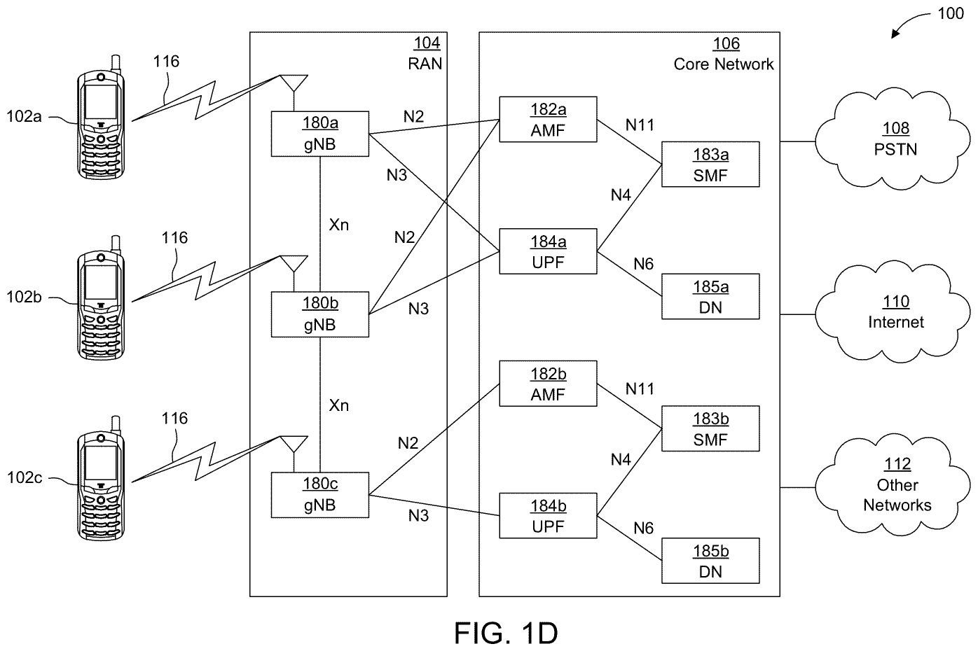

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Access Technology refers to the access technology associated with a PLMN or SNPN. The WTRU or UE uses this information to determine what type(s) of radio carrier to search for when attempting to select a specific PLMN or SNPN. The access technologies may include: GSM, UTRAN, GSM COMPACT, EC-GSM-IoT, cdma2000 1×RTT, cdma2000 HRPD, E-UTRAN (WB-S1 mode and NB-S1 mode), NG-RAN, satellite NG-RAN and satellite E-UTRAN (WB-S1 mode and NB-S1 mode). A PLMN may support more than one access technology. SNPNs only support NG-RAN.

An allowable PLMN may refer to a PLMN that is available to a user. This may be a case of a mobile station or WTRU operating in operation mode A or B, this is a PLMN which is not in a list of “forbidden PLMNs” that resides in the WTRU. This may also be case of a WTRU operating in operation mode C or a WTRU not supporting A/Gb mode and not supporting Iu mode, this is a PLMN which is not in the list of “forbidden PLMNs” and not in a list of “forbidden PLMNs for GPRS service” that resides in the WTRU.

An allowable SNPN may refer to a WTRU operating in an SNPN mode access operation mode. This may be a case of a WTRU operating in SNPN access operation mode over 3GPP access and for an SNPN candidate which is not an SNPN selected for localized services in SNPN, which is an SNPN not in the list of “permanently forbidden SNPNs” and is not in the list of “temporarily forbidden SNPNs.” A WTRU may maintain a list of “temporarily forbidden SNPNs” and a list of “permanently forbidden SNPNs.” Each entry of those lists consists of an SNPN identity. The list of “permanently forbidden SNPNs” is if the WTRU supports access to an SNPN using credentials from a credentials holder, equivalent SNPNs or both, associated with the selected entry of the “list of subscriber data” or the selected PLMN subscription, and is not in the list of temporarily forbidden SNPNs.” The list of “temporarily forbidden SNPNs” is if the WTRU supports access to an SNPN using credentials from a credentials holder, equivalent SNPNs or both, associated with the selected entry of the “list of subscriber data” or the selected PLMN subscription. Allowable SNPN may be case of WTRU operating in SNPN access mode and for an SNPN candidate which is an SNPN selected for localized services in SNPN, this is an SNPN which is not in the list of “permanently forbidden SNPNs for access for localized services in SNPN” which is associated with the selected entry of the “list of subscriber data” or the selected PLMN subscription, and is not in the list of “temporarily forbidden SNPNs for access for localized services in SNPN” which is associated with the selected entry of the “list of subscriber data” or the selected PLMN subscription.

Allowable PLMN/access technology combination may apply to a WTRU operating in operation mode C or a WTRU not supporting A/Gb mode and not supporting Iu mode; this is an allowable PLMN in any specific access technology. For an WTRU (MS) operating in WTRU operation mode A or B, this is a PLMN/access technology combination where: the PLMN is an allowable PLMN and the specific access technology is supporting non-GPRS services, or 3GPP, and the PLMN is not in the list of “forbidden PLMNs” and not in the list of “forbidden PLMNs for GPRS service” in the WTRU and the specific access technology is only supporting GPRS services.

Camped on a cell may apply to a WTRU (mobile equipment (ME) if there is no SIM) that has completed the cell selection/reselection process and has chosen a cell from which it plans to receive all available services. Note that the services may be limited, and that the PLMN or the SNPN may not be aware of the existence of the WTRU (ME) within the chosen cell.

Current serving cell may apply to the cell on which the WTRU is camped.

Home PLMN is a PLMN where the MCC and MNC of the PLMN identity match the MCC and MNC of the IMSI.

Visited PLMN is a PLMN different from the HPLMN (if the EHPLMN list is not present or is empty) or different from an EHPLMN if the EHPLMN list is present.

In A/Gb mode may apply only to a GSM system which operates in A/Gb mode. For a multi system case this is determined by the current serving radio access network.

In Iu mode may apply only to UMTS. For a multi system case this is determined by the current serving radio access network.

In S1 mode may apply only to an EPS. The S1 mode includes WB-S1 mode and NB-S1 mode. For a multi system case this is determined by the current serving radio access network.

In N1 mode may apply only to an 5GS. For a multi system case this is determined by the current serving radio access network.

Registered PLMN (RPLMN) is the PLMN on which certain LR outcomes have occurred. In a shared network the RPLMN is the PLMN defined by the PLMN identity of the CN operator that has accepted the LR.

Registration is the process of camping on a cell of the PLMN or the SNPN and doing any necessary LRs.

Selected PLMN is the PLMN that has been selected, for example, according to clause 3.1 of 3GPP TS 23.122, either manually or automatically.

Steering of Roaming (SOR) is a technique whereby a roaming WTRU is encouraged to roam to a preferred roamed-to-network indicated by the HPLMN.

Steering of Roaming application function (SOR-AF): An application function that can provide UDM with one of the following:
a) one or more of the following: a list of preferred PLMN/access technology combinations; SOR-CMCI, together with the “Store SOR-CMCI in ME” indicator if applicable; SOR-SNPN-SI; and SOR-SNPN-SI-LS;
b) a secured packet, together with the indicator, if applicable, that “the list of preferred PLMN/access technology combinations is not included in the secured packet”; or
c) neither of a) or b), generated dynamically based on operator specific data analytics solutions.

In the following description, the terms RAN Node, Base Station, eNodeB, and gNodeB are used interchangeably.

A WTRU may take a number of actions for handling of RAT Utilization information. For example, a WTRU may provide, to a home network, information about its capability to support RAT Utilization feature. The RAT Utilization capability support in the WTRU could be derived by the WTRU with presence of the new elementary file in the UICC, for example, EF_{RATUtilInfo}, which may be an elementary file for storage of RAT Utilization information or based on a configuration provided by the user of the WTRU.

The WTRU may receive RAT Utilization information from the home network. The WTRU may store and/or update the RAT Utilization information in a nonvolatile random-access memory (NVRAM) of the WTRU and if the UICC supports new elementary file (EF_{RATUtilInfo}) for the RAT Utilization, it may store the latest received RAT Utilization information to the SIM card. The received RAT Utilization information may replace any existing stored RAT Utilization information in the WTRU/USIM. A roaming WTRU may receive information from a visited network. The information from the visited network may indicate how, or whether, the WTRU should use the RAT Utilization information.

The WTRU may take into consideration broadcast information of the VPLMN (VPLMN_ID_1) along with the locally WTRU/SIM (ME/USIM) stored RAT Utilization information to modify the PLMN selection process. The WTRU NAS layer may provide the applicable RAT Utilization/restriction information to the access stratum, and this may ensure that access stratum can optimize its cell searches, disable bands and frequencies which correspond to the restricted RATs, and not respond to measurement control messages from the access network (eNB/gNB) for unsupported RATs.

RAT Utilization information may include RAT restrictions linked with time and location, the WTRU NAS layer may ensure that any change in validity conditions, for example time and/or location validity conditions are handled appropriately. Thus, a WTRU entering restricted location and/or a WTRU coming out of restricted time window may be handled appropriately. For example, a change in validity conditions may trigger fresh cell selection process which may result in enabling/disabling of certain radio access technologies.

The WRTU may modify its radio capabilities according to the currently active RAT Utilization information and inform the network about its currently supported radio access technologies. This may enable the network to configure its access networks (eNB/gNB) to ensure that the access network does not trigger any reselection or handover to non-supported access technologies. The information about the modified radio capabilities may be provided to inform the network, via NAS signaling messages, of a Mobility/Periodic Registration procedure, UL NAS Transport procedure, and the like. The WTRU may then register with the visited network without the problems that may occur with existing mechanisms such as higher signaling loads within the network to transmit the attach/TAU/Registration request messages and subsequent reject messages, service outage for the WTRU until the WTRU selects another RAT, and with the WTRU re-attempting to attach to the same PLMN/RAT upon the WTRU re-enabling the corresponding RAT, for example, the WTRU implementation specific timer based disabling/re-enabling of the RAT.

A RAN may perform certain actions when handling RAT Utilization information. The RAN Node may determine that the RAT Utilization feature should be enabled. The RAN Node may make this determination based on detecting a congestion condition in the network or based on configuration information. For example, the RAN Node may receive an indication from the core network that there is congestion in the network. The RAN Node may determine that this congestion in the network is based on the number of WTRUs using the RAN Node to connect to the core network. The RAN Node may determine that this congestion in the network is based on information that is received from the OAM system. The RAN node may directly receive an indication from the network that a RAT utilization restriction should be enforced. When the RAN Node determines that the RAT Utilization feature should be enabled, the RAN Node may also determine which RAT Utilization list should be used by WTRUs. For example, the RAN Node may determine that utilization of a first RAT should be restricted but that utilization of a second RAT does not need to be restricted. The RAN Node may have determined that the congestion situation only applies to a first RAT but not to the second RAT. Therefore, the RAN Node may determine that it is preferred that a WTRU use a RAT Utilization list that restricts utilization of the first RAT but does not restrict utilization of the second RAT.

The RAN Node may receive an OnDemand system information block request from a WTRU requesting the RAN node to broadcast a specific SIB, for example a SIB containing the RAT Utilization feature status (enabled/disabled) and RAT Utilization list identifier. The SIB containing the RAT Utilization feature status may indicate that the RAT Utilization feature is enabled or disabled

The RAN Node may broadcast an indication of the whether or not the RAT Utilization feature is enabled. As described above, the indication of the whether or not the RAT Utilization feature is enabled may be transmitted in a SIB. In the case the RAT Utilization feature is enabled, the RAN Node may broadcast a RAT Utilization List Identifier.

A Non-Public Network (NPN) is a 5GS deployed network which is for non-public use. An NPN may be a Stand-alone Non-Public Network (SNPN), i.e. operated by an NPN operator and not relying on network functions provided by a PLMN, or a Public Network Integrated NPN (PNI-NPN), i.e., a non-public network deployed with the support of a PLMN.

A Non-public network (NPN) may be intended for the use of a private entity such as an enterprise or a factory. A SNPN can be identified by a combination of PLMN ID and Network Identifier (NID), where the PLMN ID may be, for example, a reserved PLMN IDs for private networks with Mobile Country Code=999.

The architecture of a 5G SNPN is based on the architecture of 5G System. The NG-RANs of the SNPN may broadcast the combination of PLMN IDs and NIDs. A WTRU operating in SNPN access mode may read the broadcast system information for available (PLMN ID+NID)'s and select the SNPN for which it has a valid subscription and credentials.

A Public Network Integrated Non-Public Network (PNI-NPN) is a Non-Public Network made available using PLMN infrastructure/resources, for example, a PLMN network slice. A group of PLMN users which are allowed to access a certain PNI-NPN may be referred to as a Closed Access Group (CAG) and a CAG is identified by a CAG identifier. CAG users can only access a PNI-NPN from a cell that supports CAG access, which is called a “CAG cell.” A CAG cell broadcasts a list of CAG identifiers that it supports. A CAG WTRU may be configured by the network with a list of CAGs that it can access (Allowed CAG List). When a CAG WTRU detects a CAG cell, it may only select/access the CAG cell if at least one of the broadcasted CAG identifier(s) matches one of the CAG identifiers in its Allowed CAG List.

In some circumstances, a cellular network may be deployed to provide services to local users within a certain area. This may be a 5G network Providing Access to Localized Services (PALS network). For example, a temporary non-public cellular network may be set up to provide a streaming video service to the audience in a live concert or sporting event. As another example, in places like airports, shopping malls and school campuses, where a large crowd may gather, cellular networks may be deployed to provide localized services, such as commercial ads in the shopping mall. The services provided by these small networks have two basic characteristics: first, the services are localized, meaning that they are related to the activities/events in a certain location or area, and are usually limited to the users within the area; and second, the users don't utilize these services on a regular basis but most likely in an on-demand or temporary fashion.

5G system developments are desired to provide such localized services and enable users to access the hosting network that provides these services. In the following description, these localized services are referred to as “PALS service” or “localized services,” and the network(s) that provides PALS services may be referred to as “PALS network” or “PALS hosting network” or simply “hosting network.”

A hosting network may be a Standalone Non-Public Network (SNPN), or a Public Network Integrated Non-Public Network (PNI-NPN), or a PLMN. The local service provider may be the hosting network operator or a 3rd party service provider.

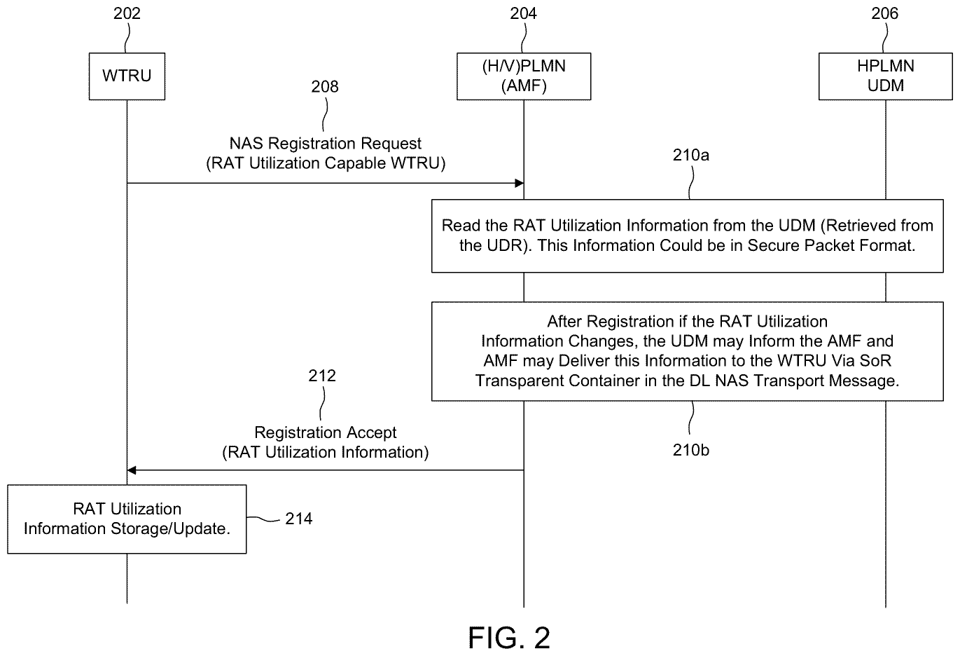

The network selection is the process by which the WTRU performs the radio scan to check the availability of the PLMNs at its current location and tries to register to the PLMN. When powering on or following a recovery form lack of coverage, a WTRU may select a PLMN that the WTRU last registered with (if it's available) using the last registered access technology and attempt to perform the registration procedure. If the PLMN that the WTRU last registered with is not available, then the WTRU may scan all RF channels in all supported bands and access technologies according to its capabilities to find available PLMNs. On each carrier (i.e. channel), the WTRU shall search for the strongest cell and read its system information. The system information is read in order to find out which PLMN the cell belongs to. If there is no last registered PLMN, or if registration is not possible due to the PLMN being unavailable or if registration fails, the WTRU may, for example, follow the procedures in clause 4.4.3 and as illustrated in FIG. 2a in clause 5 of 3GPP TS 23.122 depending on its network selection mode (Automatic vs manual mode of selection).

The priority order for the network selection and registration for the PLMN/Access technologies combination may be as follows: a) either the HPLMN (if the EHPLMN list is not present or is empty) or the highest priority EHPLMN that is available (if the EHPLMN list is present); b) each PLMN/access technology combination in the “User Controlled PLMN Selector with Access Technology” data file in the SIM (in priority order); c) each PLMN/access technology combination in the “Operator Controlled PLMN Selector with Access Technology” data file in the SIM (in priority order) or stored in the WTRU (in priority order); and d) other PLMN/access technology combinations with received high quality signal in random order.

A WTRU may be configured with a list of equivalent PLMNs. The PLMNs that are in the list of equivalent PLMNs are regarded by the WTRU as equivalent to each other for PLMN selection and cell selection/re-selection. Configuring the WTRU with a list of equivalent PLMNs means that the WTRU receives a list of equivalent PLMNs from the network and then the WTRU stores the list of equivalent PLMNs in memory. For example, the WTRU may receive the list of equivalent PLMNs in a Registration Accept message and then the WTRU may store the list of equivalent PLMNs in memory.

The list of equivalent PLMNs includes a list of PLMN IDs. Each PLMN ID is composed of at least an MNC and an MCC. It may be possible to derive a PLMN ID from the WTRU's SUPI. For example, an IMSI is a type of SUPI and an IMSI may contain a PLMN ID. The PLMN ID that is derived from the WTRUs SUPI is the PLMN ID of the WTRU's home network operator. The WTRU may also be configured with an Equivalent HPLMN list. The Equivalent HPLMN list is a list of PLMN IDs and the WTRU may regard the PLMN(s) in this list as equivalent to each other for PLMN selection and cell selection/re-selection.

Roaming services (national and international roaming) are vital for ensuring seamless connectivity, especially in areas where the home network operator lacks coverage. However, allowing inbound roamers unrestricted use of the radio access technologies (RATs) of the visited network can pose technical issues which can further degrade the visited network performance. Examples of issues that may be triggered by a large number of inbound roamers with unrestricted access to a network's radio access technologies include: network congestion, QoS degradation, interoperability issues, and overload.

The existing mechanism to limit the WTRU's utilization of certain RATs of various networks involves rejecting the WTRU's attach/TAU/Registration request and may include a cause code, for example indicating no suitable cells in tracking area or a cause code indicating N1 mode not allowed, in the rejection message when the WTRU attempts to attach/register via a specific RAT. As previously stated, existing mechanism may result in: higher signaling loads within the network to transmit the attach/TAU/Registration request messages and subsequent reject messages, service outage for the WTRU until the WTRU selects another RAT, and the WTRU re-attempting to attach to the same PLMN/RAT upon the WTRU re-enabling the corresponding RAT, for example, the WTRU implementation specific timer based disabling/re-enabling of the RAT.

FIG. 2 illustrates an example procedure of the delivery and storage of the RAT utilization information signaling between a PLMN and WTRU during the registration procedure. At 208, WTRU 202 performs a registration procedure, for example on a 5G mobile network, with a home PLMN (HPLMN). The registration procedure may be an initial registration, mobility, or periodic registration procedure. The example described is with reference to a 5G service (5GS), however, a similar mechanism can be extended to future generation networks, 4G (LTE), or previous generation networks (3g/2g) networks where in the registration procedure is replaced with the attach and tracking area update procedures or other NAS control plane signaling procedures. WTRU 202 may provide additional information about its capability to support the RAT Utilization feature. The RAT Utilization capability support in the WTRU may be derived by the WTRU based on the presence of the new elementary file in the UICC, for example, EF_{RATUtilInfo} an elementary file for storage of RAT Utilization information, or based on the configuration provided by the user of the WTRU. Alternatively, the RAT Utilization capability support may be pre-configured in the WTRU.

At 210a, a network function, for example an AMF, on reception of the NAS registration message with the additional support for RAT Utilization features, may read the RAT Utilization information from the UDM/UDR identified for the subscription linked with the WTRU (SUPI/IMSI). In an embodiment, which, for ease of reference may be called option-1, the RAT Utilization information includes information about the RAT Utilization/restrictions for specific roaming partners or PLMNs, For example, the information may indicate which radio access technologies are allowed/not allowed, with validity in scope of time and location for the WTRU roaming partners which may be considered visited PLMNs during national or international roaming. This information is configured within the HPLMN UDM/UDR based on the service level agreements (SLAs) the home operator has with national and international roaming operators.

Provided that the WTRU supports the new UICC elementary file (EF_{RATUtilInfo}) for RAT Utilizations storage, additionally based on operator deployment and policy, and the if the UDM supports communication with the Secure Packet Application Function (SP-AF), it can send the RAT Utilization information to the SP-AF requesting it to provide this information in a secured packet, for example as defined in 3GPP TS 29.544, to be sent to the WTRU.

The RAT Utilization information provided by the PLMN/HPLMN may include a list of PLMNs for RAT Utilization information, where each entry in the list may include a corresponding PLMN Identifier and RAT validity information for each RAT associated with the PLMN identifier.

RAT validity information may include location validity information and time validity information. The location validity information may include a whitelist of TAI's/Cell IDs or Blacklist of TAI's/Cell IDs. The location validity may indicate that one or more RATs are not allowed for the whole PLMN. The time validity information may include a time period when a RAT usage is allowed or not allowed. The time period may be specified as a relative time, for example valid for next 8 hours or valid until Date1, Time1). Alternatively, the time period may be specified as an absolute range, for example valid between (Date2, Time2) and (Date3, Time3). Alternatively, the time period may be specified as a recurring range, for example valid every day between (Time4) and (Time5).

In a case where only time validity is present, this would mean that the RAT restrictions are only applicable in the time domain and no location restrictions are applicable. A wild card time value may be considered as restrictions that are permanent. In a case where only location validity information is present, this would mean RAT restrictions are only applicable in the location domain and no time based restrictions are applicable. A PLMN ID or other wild card character as a value for the location validity parameter may be considered as location validity being applicable for the entire PLMN.

In a case where the RAT validity information values do not include location and time validity information it may mean that the RAT is allowed indefinitely, without restriction, for the entire PLMN. Alternatively, a case where the RAT validity information values do not include location and time validity information it may mean that RAT is not allowed for an indefinite time, restricted, for the entire PLMN.

Thus, the RAT Utilization information provided by the PLMN/HPLMN may include one or more PLMN identifiers and RAT validity information for each of one or more RATs associated with each of the one or more PLMN identifiers, for example RAT-1, RAT-2 . . . . RAT-N. RATs that are not part of, or included in, the list are considered as not supported by the respective PLMN.

In an alternative embodiment, the RAT Utilization information may include multiple entries for each of one or more PLMNs (roaming partners) where the multiple entries for each of the one or more roaming partners (PLMNs) includes: an entry identifier, a PLMN identifier, and corresponding RAT validity information. For example, the RAT Utilization information may include:
List_ID_1, PLMN_ID_1, List definition as per option-1 for RAT Utilization information;
List_ID_2, PLMN_ID_1, List definition as per option-1 for RAT Utilization information; and
List_ID_3, PLMN_ID_1, List definition as per option-1 for RAT Utilization information.

The above example is provided for ease of description and should not be considered limiting in any aspect. There may be more entries or less entries for each PLMN, and there may be entries for more than one PLMN. For ease of description only, this embodiment may be referred to as option-2.

In another alternative embodiment, The Operator Controlled PLMN Selector with Access Technology (OPLMN), which is controlled by the mobile network operator, may be further modified to include the RAT Utilization information. For example, each entry in the OPLMN list would have a validity information extension for each supported access technology identified by the access technology identifier. This may include the location validity and time validity as described above. That is, location validity Information including a whitelist of TAI's/Cell IDs or Blacklist of TAI's/Cell IDs, and/or an indicator that that the RAT is restricted for the entire PLMN, and time validity information including a time period when RAT usage is allowed or not allowed.

Alternatively, at 210b changes in the RAT Utilization information may be communicated by UDM/UDR 206 to AMF 204 and AMF 204 would deliver the updated RAT Utilization information to the WTRU via the NAS DL NAS TRANSPORT message as part of the Steering of Roaming (SoR) transparent container. This update of the RAT Utilization information may happen while WTRU 202 is registered on the HPLMN or the visited PLMN (VPLMN).

At 212, the network function, for example AMF 204, delivers the RAT Utilization information to WTRU 202 via the NAS Signaling response i.e. the Registration Accept Message. AMF 204 may deliver this via other NAS signaling messages as well, for example a DL NAS Transport message, a Configuration Update Command message etc.

At 214, WTRU 202 may store and/or update the RAT Utilization information in the WTRU NVRAM, and if the UICC supports new elementary file (EF_{RATUtilInfo}) for the RAT Utilization, WTRU 202 would store the latest received RAT Utilization information to a SIM card in the WTRU. The received RAT Utilization information may replace any existing stored RAT Utilization information in the WTRU/USIM.

In the example illustrated in FIG. 2, the AMF receives an indication that the WTRU supports the RAT Utilization feature. Reception of this indication may trigger to the AMF to subscribe to the UDM/UDR to receive a notification if the WTRU's RAT Utilization information changes. In a case where the UDM/UDR sends a notification to the AMF, the notification can include the WTRU's RAT Utilization information. Reception of the notification may cause the AMF to send a WTRU (UE) Configuration Update message to the WTRU. The WTRU (UE) Configuration Update message may include the WTRU's RAT Utilization information. Reception of new RAT Utilization information may trigger the WTRU to deregister from the network and perform a PLMN or cell selection/reselection procedure. Alternatively, the WTRU (UE) Configuration Update message may include an indication that the WTRU should trigger a PLMN or cell selection procedure.

The Steering of roaming Application function (SOR-AF) (not shown) may send a Nudm_ParameterProvision_Update request to the UDM/UDR to trigger the update of the WTRU with the updated RAT Utilization information. The UDM/UDR may notify the changes of the RAT Utilization information to the affected AMF by the means of invoking Nudm_SDM_Notification service operation. The affected AMF is in the selected PLMN, while selected PLMN could be a HPLMN or a VPLMN. The Nudm_SDM_Notification service operation contains the steering of roaming information (including the RAT Utilization Information) that may need to be delivered transparently to the WTRU over NAS within the Access and Mobility Subscription data. The AMF may send a DL NAS TRANSPORT message to the served WTRU. The AMF includes in the DL NAS TRANSPORT message the steering of roaming information received from the UDM/UDR. Reception of new RAT Utilization information may trigger the WTRU to deregister from the network and perform a PLMN or cell selection/reselection procedure. Alternatively, the DL NAS TRANSPORT message may include an indication that the WTRU should trigger a PLMN or cell selection procedure.

The procedure may also be applicable in the case of international roaming. In this case, when the WTRU is powered on with the international roaming PLMN, the RAT utilization information described above will be transmitted to the WTRU by the HPLMN for a possible roaming partner PLMN(s) (operators) in that country. This information is sent to the WTRU through the already defined steering of roaming (SoR) procedure.

In another alternative embodiment, the “Temporary available Network Slices” feature, or the “UE Network Slice usage behavior” feature may be used to associate S-NSSAIs to RATs that should or should not be used, for example during a certain time period, or for certain location, when the WTRU is using specific services on specific network slices.

For example, a WTRU that has registered and indicated both its ability to support RAT Utilization and “Temporary available Network Slices” (i.e., support for S-NSSAI time validity information) may be given, by the network, an indication of what RATs can be used with what network slices, during a certain time period(s), in a certain location(s).

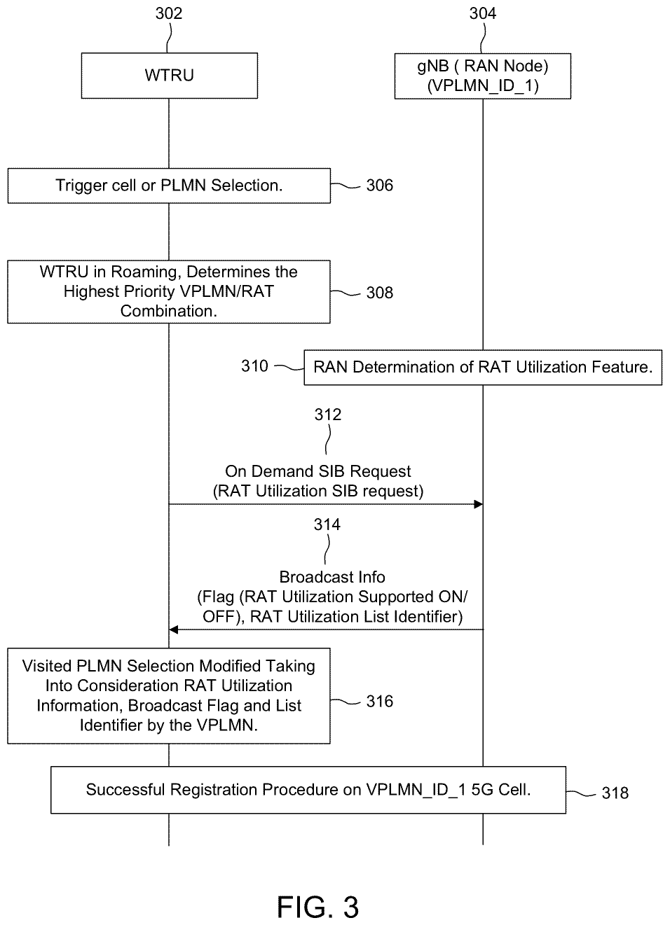

FIG. 3 illustrates an example procedure of how the RAT utilization information is used by the WTRU for the PLMN selection process while the WTRU is in a roaming environment (national or international roaming).

The procedure of FIG. 3 illustrates how a RAN Node 304 may use broadcasted information to control whether and how WTRU 302 applies the RAT Utilization feature. Thus, the procedure of FIG. 2 may be used to deliver the RAT Utilization from the home network to the WTRU. Then, the procedure of FIG. 3 may be used by a visited network to control whether and how the WTRU applies the RAT Utilization feature. The combined approaches of FIG. 2 and FIG. 3 may be used together to realize an improvement in cell/PLMN selection/reselection. For example, a WTRU can be configured with the RAT Utilization Information from the home network, and the visited network may control when the restrictions that are associated with the RAT Utilization Information are applicable. It is expected that a relatively large amount of time may pass between the WTRU being configured with the RAT Utilization Information and the WTRU attempting to register in the VPLMN where the RAT Utilization Information applies. For example, the WTRU may receive the RAT Utilization Information and, several days later enter “airplane mode” or “power down” while on a flight. The WTRU may then exit “airplane mode” or power back on when the flight arrives in a different country and then attempt to register in the VPLMN. Thus, network conditions in the VPLMN cannot be known when the RAT Utilization Information is sent to the WTRU.

At 306, the WTRU determines to perform a cell or a PLMN selection procedure. As described with reference to FIG. 2, the cell or PLMN selection procedure may be triggered by reception of new RAT Utilization Information or may be triggered by an explicit indication from the network (e.g. an indication in a WTRU Configuration Update message). Alternatively, the PLMN selection procedure may be triggered by the WTRU powering on, disabling airplane mode, returning from lack of coverage, performing a periodic search for a higher priority PLMN, or based on a request from the user of the WTRU.

At 308, WTRU 302 is in roaming environment (national or international), for example, the WTRU does not have access to the Home PLMN and may look for available PLMNs in the priority order. This may, for example, follow the process defined in the clause 4.4 “PLMN Selection Process” as per 3GPP TS 23.122. Another assumption here is that the WTRU supports the RAT Utilization feature and has the RAT Utilization information provided by the home operator stored either in the WTRU and/or UICC. For example, this may be provided during an earlier registration procedures. In the example scenario, as per the priorities defined in various PLMN selector lists, the WTRU determines VPLMN as the highest priority PLMN, identified as VPLMN_ID_1. This may, for example, be the process as in clause 4.4 “PLMN selection Process” per 3GPP TS 23.122.

At 310, RAN Node 304 determines that the RAT Utilization feature should be enabled. RAN Node 304 may make this determination based on detecting a congestion situation in the network or based on configuration information. For example, the RAN Node may receive an indication from the core network that there is congestion in the network; the RAN Node may determine that this congestion in the network is based on the number of WTRU's that are using the RAN Node to connect to the core network; the RAN Node may determine that this congestion in the network is based on information that is received from the OAM system; the RAN node may directly receive the indication from the network that the RAT utilization restriction should be enforced.

When RAN Node 304 determines that the RAT Utilization feature should be enabled, RAN Node 304 may also determine which RAT Utilization list should be used by WTRUs. The RAT Utilization list information is provided by the core network to RAN Node 304. For example, the RAN Node may determine that utilization of a first RAT should be restricted but that utilization of a second RAT does not need to be restricted or the RAN Node may have determined that the congestion situation only applies to a first RAT but not to the second RAT. Therefore, RAN Node 304 may determine that it is preferred that WTRU 302 use a RAT Utilization list that restricts utilization of the first RAT and does not restrict utilization of the second RAT.

At 312, WTRU 302 may, as an optional process, transmit a system information on demand request to RAN Node 304. The system information on demand request is a request from WTRU 302 to RAN Node 304 for the RAN Node to broadcast a specific SIB. The specific SIB that is requested in this process is the SIB that indicates whether the RAT Utilization Feature is enabled and the SIB that can be used to broadcast the RAT Utilization list identifier.

At 314, WTRU 302 listens to the broadcast channel of gNB/RAN Node 304 of the VPLMN_ID_1, which is broadcasting information with respect to the RAT Utilization i.e. a flag which indicates if RAT Utilization is supported or not (ON/OFF flag) and additional information about the list identifier. This refers to the entry list of the RAT Utilization information where the WTRU is provided with multiple entries identified via unique list identifiers and each list has its own set of RAT Utilization/restriction information i.e. time and location validity information. This is the information referenced an option-2, which again is simply for ease of description.

At 314, RAN Node 304 broadcasts an indication of whether or not the RAT Utilization feature is enabled. The determination of whether to enable the feature was made at 310. The indication of the whether or not the RAT Utilization feature is enabled may be transmitted in a SIB.

Also at 314, if RAT Utilization feature is enabled, the RAN Node broadcasts a RAT Utilization List Identifier. The determine of which RAT Utilization List Identifier to broadcast was made at 310. The RAT Utilization List Identifier may be transmitted in a SIB.

At 316, WTRU 302 may take into consideration the broadcast information transmitted by gNB 304 with the VPLMN (VPLMN_ID_1) along with the locally (WTRU/USIM) stored RAT Utilization information to modify the PLMN selection process.

For example, the gNB/RAN Node of the VPLMN_ID_1 broadcast information that the RAT Utilization feature is supported, if no list identifiers (the lists referenced as option-2) are broadcast, the WTRU would use the stored RAT Utilization information to determine the access technologies for the VPLMN_ID_1 which are currently allowed for the WTRU to access. The WTRU will disable non-supported access technologies, for example if 4G is not supported for VPLMN_ID_1 and is locally disabled for Cell selection process. The WTRU will try to find cells in the supported access technologies for the purpose of cell selection and once successfully camped on the cell, the WTRU would trigger the registration procedure. In the example scenario the WTRU chooses a cell on the 5G for the VPLMN_ID_1 and ignores 4G cells.

In another example, if VPLMN_ID_1 broadcasts list identifier, the WTRU will take RAT Utilization information corresponding to the broadcast list identifier to modify the cell selection process (enabling/disabling radio access technologies).

In other words, the WTRU will use the broadcasted indication of whether or not the RAT Utilization feature is enabled to determine whether to consider RAT Utilization information in a PLMN selection procedure. Furthermore, the WTRU will use the broadcasted RAT Utilization List Identifier to determine which RAT Utilization information to use in the PLMN selection procedure.

The WTRU NAS layer may provide the applicable RAT Utilization/restriction information to the access stratum, and this would ensure that access stratum can optimize its cell searches, disable bands and frequencies which correspond to the restricted RATs, and not respond to the measurement control messages from the access network (eNB/gNB) for unsupported RATs.

Aa another consideration, if the RAT Utilization feature is supported by the visited PLMN, any equivalent PLMNs provided during the registration procedure by the visited PLMN shall have the same set of RAT Restrictions. That is, RAT restrictions for registered and its equivalent PLMNs are the same.

As RAT Utilization information may have RAT restrictions linked with time and location, the WTRU NAS layer may need to ensure that any change in validity conditions (time/location), for example a WTRU entering restricted location and a WTRU coming out of restricted time window are appropriately handled. In other words, a change in validity conditions may trigger fresh cell selection process which might result in enabling/disabling of certain radio access technologies.

The WTRU may modify its radio capabilities as per the currently active RAT Utilization information and inform the network about its current supported radio access technologies. This would enable the network to configure its access networks (eNB/gNB) to ensure that the access network does not trigger any reselection or handover to non-supported access technologies. The information about the modified radio capabilities may be informed to the network via NAS signaling messages i.e. Mobility/Periodic Registration procedure, UL NAS Transport procedure etc.

At 318, WTRU 302 selects the 5G cell of the VPLMN_ID_1 and triggers successful registration procedure.

Alternatively, the visited PLMN may not broadcast any information about the RAT Utilization feature, and the WTRU may use the stored RAT Utilization information provided by the Home PLMN for the PLMN and cell selection process. Once the WTRU has determined the cell to camp on, taking into consideration enabled/disabled radio access technologies, it will trigger the registration procedure. The WTRU may provide additional information in the registration message, for example the that RAT Utilization feature is supported by the WTRU and it has used RAT Utilization information to enable/disable certain access technologies for the currently selected PLMN. This would give the visited PLMN the opportunity to either accept the registration procedure, honor the RAT Utilization information used by the WTRU, or Accept/Reject the registration procedure and indicate that there is no support for the RAT Utilization feature. On reception of the Reject or RAT Utilization feature not being supported by the visited PLMN, the WTRU may either enable all access technologies, and perform another registration procedure with RAT Utilization feature disabled (i.e. not including information bit in the registration procedure about RAT Utilization feature) or select a different PLMN, which may correspond with the PLMN selection process clause 4.4. of 3GPP TS 23.122.

Since Equivalent PLMNs are equivalent for the purposes of PLMN selection, it should be understood that, in the procedure of FIG. 2, the WTRU may receive RAT Utilization Information that is associated with a first PLMN ID. Later, when the WTRU determines to perform the procedure of FIG. 3 with a RAN Node that is associated with a second PLMN ID, the WTRU may use the RAT Utilization Information that is associated with a first PLMN ID. For example, the WTRU may choose to use the RAT Utilization Information that is associated with a first PLMN ID when determining whether to select another PLMN that is associated with a second PLMN ID because the WTRU has been configured with information that indicates that the first PLMN ID and second PLMN ID are equivalent. In other words, the first PLMN ID and second PLMN ID may have a different value but are equivalent.

When no other PLMN but the PLMN of the restricted RAT is available according to the configured RAT utilization information, the WTRU may disregard the RAT restriction and try to register with the PLMN over the restricted RAT.

In another scenario, when the WTRU's registered PLMN (HPLMN or VPLMN) has a disaster situation and the WTRU is forced to roam into other PLMNs, if only the PLMN of the restricted RAT is available, the WTRU may disregard the RAT restriction and try to register with the PLMN over the restricted RAT.

When above situations happen, the WTRU may start a timer after registering with the PLMN of the restricted RAT. After the timer expires, the WTRU may search for other PLMNs of non-restricted RAT, and if they are available, the WTRU may try to reselect to those PLMNs. Otherwise, it stays with the PLMN of the restricted RAT and restarts the timer. The timer value may be configured as part of RAT Utilization information by the HPLMN.

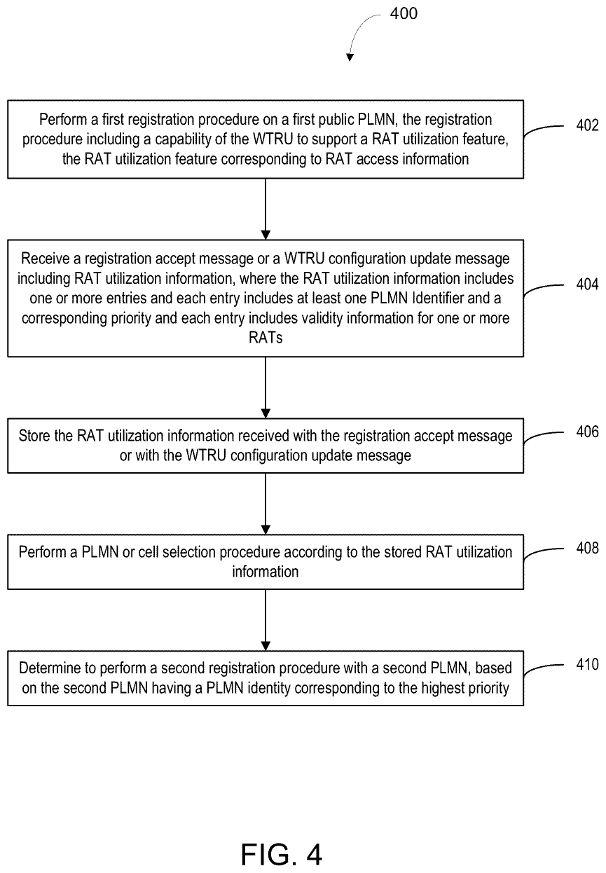

FIG. 4 illustrates a RAT utilization process implemented in a WTRU. As shown in FIG. 4, process 400, at 402, may include performing a first registration procedure on a first public land mobile network (PLMN), where the registration procedure includes a capability of the WTRU to support a RAT utilization feature, the RAT utilization feature corresponding to RAT access information. For example, a WTRU may perform a first registration procedure on a first PLMN where the registration procedure includes a capability of the WTRU to support the RAT utilization feature where the RAT utilization feature corresponds to RAT access information, as described above. As also shown in FIG. 4, process 400, at 404, may include receiving a registration accept message or a WTRU configuration update message including RAT utilization information, where the RAT utilization information includes one or more entries and each entry includes at least one PLMN Identifier and a corresponding priority, and each entry includes validity information for one or more RATs. For example, the WTRU may receive a registration accept message or a WTRU configuration update message including RAT utilization information where the rat utilization information includes one or more entries and each entry includes at least one PLMN identifier and a corresponding priority, and each entry includes validity information for one or more rats, as described above. As further shown in FIG. 4, process 400, at 406 may include storing the RAT utilization information received with the registration accept message or with the WTRU configuration update message. For example, the WTRU may store the RAT utilization information received with the registration accept message or with the WTRU configuration update message, as described above. As also shown in FIG. 4, process 400, at 408, may include performing a PLMN or cell selection procedure according to the stored RAT utilization information. For example, the WTRU may perform a PLMN or cell selection procedure according to the stored RAT utilization information, as described above. As further shown in FIG. 4, process 400, at 410, may include determining to perform a second registration procedure with a second PLMN based on the second PLMN having a PLMN identity corresponding to the highest priority. For example, the WTRU may determine to perform a second registration procedure with a second PLMN, based on the second PLMN having a PLMN identity corresponding to the highest priority, as described above.

Process 400 may include additional implementations not shown, such as any single implementation or any combination of implementations described below and/or in connection with one or more other processes described elsewhere herein. In a first implementation, the RAT utilization information includes multiple entries for each of one or more other PLMNs where the multiple entries for each of the one or more other PLMNs includes: an entry identifier, a PLMN identifier, and corresponding RAT validity information.

In a second implementation, alone or in combination with the first implementation, the WTRU configuration update message includes updated RAT utilization information when the RAT utilization information is changed. In a third implementation, alone or in combination with the first and second implementation, the RAT utilization information is included in an operator controlled PLMN selector with access technology (OPLMN) controlled by a mobile network operator.

In a fourth implementation, alone or in combination with one or more of the first through third implementations, updated RAT utilization information is received via a non-access stratum (NAS) downlink (DL) NAS transport message as part of a steering of roaming (SoR) transparent container. In a fifth implementation, alone or in combination with one or more of the first through fourth implementations, the RAT utilization information includes WTRU network slice parameters including location validity information and time validity information.

A sixth implementation, alone or in combination with one or more of the first through fifth implementations, process 400 may include receiving broadcast information from a network node, the broadcast information including a flag to indicate whether RAT utilization is supported. A seventh implementation, alone or in combination with one or more of the first through sixth implementations, process 400 may include transmitting a system information on demand request to the network node.

An eighth implementation, alone or in combination with one or more of the first through seventh implementations, process 400 may further include receiving an entry identifier in the broadcast information and selecting an entry from the RAT utilization information for a PLMN selection/reselection procedure based on the broadcast information received. A ninth implementation, alone or in combination with one or more of the first through eighth implementations, process 400 may include completing the second PLMN registration procedure with the second PLMN.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method of radio access technology (RAT) utilization implemented in a wireless transmit/receive unit (WTRU), the method comprising:
performing a first registration procedure on a first public land mobile network (PLMN), the registration procedure including a capability of the WTRU to support a RAT utilization feature, the RAT utilization feature corresponding to RAT access information;
receiving a registration accept message or a WTRU configuration update message including RAT utilization information, wherein the RAT utilization information includes one or more entries and each entry includes at least one PLMN Identifier and a corresponding priority and each entry includes validity information for one or more RATs;
storing the RAT utilization information received with the registration accept message or with the WTRU configuration update message;
performing a PLMN or cell selection procedure according to the stored RAT utilization information; and
determining to perform a second registration procedure with a second PLMN, based on the second PLMN having a PLMN identity corresponding to a highest priority.

2. The method of claim 1, wherein the RAT utilization information includes multiple entries for each of one or more other PLMNs, and wherein the multiple entries for each of the one or more other PLMNs includes: an entry identifier, a PLMN identifier, and corresponding RAT validity information.

3. The method of claim 1, wherein the WTRU configuration update message includes updated RAT utilization information when the RAT utilization information is changed.

4. The method of claim 1, wherein the RAT utilization information is included in an operator controlled PLMN selector with access technology (OPLMN) controlled by a mobile network operator.

5. The method of claim 1, wherein updated RAT utilization information is received via a non-access stratum (NAS) downlink (DL) NAS transport message as part of a steering of roaming (SoR) transparent container.

6. The method of claim 1, wherein the RAT utilization information includes WTRU network slice parameters including location validity information and time validity information.

7. The method of claim 1, further comprising receiving broadcast information from a network node, the broadcast information including a flag to indicate whether RAT utilization is supported.

8. The method of claim 7, further comprising transmitting a system information on demand request to the network node.

9. The method of claim 7, further comprising:
receiving an entry identifier in the broadcast information and selecting an entry from the RAT utilization information for a PLMN selection/reselection procedure based on the broadcast information received.

10. The method of claim 1, further comprising completing the second PLMN registration procedure with the second PLMN.

11. A wireless transmit/receive unit (WTRU) comprising:
processing circuitry; and
a transceiver, the transceiver configured to perform a first registration procedure on a first public land mobile network (PLMN), the registration procedure including a capability of the WTRU to support a radio access technology (RAT) utilization feature, the RAT utilization feature corresponding to RAT access information;
receive a registration accept message or a WTRU configuration update message including RAT utilization information, wherein the RAT utilization information includes one or more entries and each entry includes at least one PLMN Identifier and a corresponding priority and each entry includes validity information for one or more RATs;
the processing circuitry configured to store the RAT utilization information received with the registration accept message or with the WTRU configuration update message;
perform a PLMN or cell selection procedure according to the stored RAT utilization information; and
instruct the transceiver to perform a second registration procedure with a second PLMN, based on the second PLMN having a PLMN identity corresponding to a highest priority.

12. The WTRU of claim 11, wherein the RAT utilization information includes multiple entries for each of one or more other PLMNs, and wherein the multiple entries for each of the one or more other PLMNs includes: an entry identifier, a PLMN identifier, and corresponding RAT validity information.

13. The WTRU of claim 11, wherein WTRU configuration update message includes updated RAT utilization information when the RAT utilization information is changed.

14. The WTRU of claim 11, wherein the RAT utilization information is included in an operator controlled PLMN selector with access technology (OPLMN) controlled by a mobile network operator.

15. The WTRU of claim 11, wherein updated RAT utilization information is received via non-access stratum (NAS) control plane signaling NAS transport message as part of a steering of roaming (SoR) transparent container.

16. The WTRU of claim 11, wherein the RAT utilization information includes WTRU network slice parameters including location validity information and time validity information.

17. The WTRU of claim 16, wherein the transceiver is configured to receive broadcast information from a network node, the broadcast information including a flag to indicate whether RAT utilization is supported.

18. The WTRU of claim 17, wherein the transceiver is configured to transmit a system information on demand request to the network node.

19. The WTRU of claim 17, wherein the transceiver is configured to receive an entry identifier in the broadcast information and the processing circuitry is configured to select an entry from the RAT utilization information for the PLMN selection procedure based on the broadcast information received.

20. The WTRU of claim 11, further comprising completing the second PLMN registration procedure with the second PLMN.
